(19) United States
(12) Patent Application Publication
(10) Pub. No.: US 2010/0128491 A1
(43) Pub. Date: May 27, 2010

(54) RECESSED LUMINAIRE

(75) Inventors: SUMIO HASHIMOTO, YOKOSUKA-SHI (JP); TAKAYOSHI MORIYAMA, MIURA-SHI (JP); KAZUNARI HIGUCHI, YOKOHAMA-SHI (JP)

Correspondence Address: DLA PIPER LLP US, P. O. BOX 2758, RESTON, VA, 20195, US

(73) Assignees: TOSHIBA LIGHTING & TECHNOLOGY CORPORATION, YOKOSUKA-SHI (JP); KABUSHIKI KAISHA TOSHIBA, MINATO-KU (JP)

(21) Appl. No.: 12/624,958

(22) Filed: Nov. 24, 2009

(30) Foreign Application Priority Data
Nov. 25, 2008 (JP) 2008-300058

(51) Int. Cl. F21V 15/00

(52) U.S. Cl. 362/365; 362/364

(57) ABSTRACT

A recessed luminaire includes a main body including a light source, a terminal base attachment member, which is fire-resistant and extending laterally from the main body, and a terminal base, which is disposed on a lower surface of the terminal base attachment member and to which power wires extending in parallel in a direction of extension of the terminal base attachment member are connected.

### CROSS-REFERENCE TO RELATED APPLICATIONS

This application is based upon and claims the benefit of priority from prior Japanese Patent Application No. 2008-300058, filed Nov. 25, 2008, the entire contents of which are incorporated herein by reference.

### BACKGROUND OF THE INVENTION

1. Field of the Invention

The present invention relates to a recessed luminaire adapted for use in a recessed state in a ceiling or the like.

2. Description of the Related Art

As disclosed in Jpn. Pat. Appln. KOKAI Publication No. 2006-172895, a recessed luminaire comprises a terminal base connected to a power supply line to supply power to a light source. The terminal base and the power source are connected by a lead wire or the like, so that power is supplied to the light source. Conventionally, a type of recessed luminaire is known, in which the terminal base is directly attached to the main body of the luminaire or contained in the main body.

However, in the conventional luminaire mentioned above, dust or moisture may intrude into the terminal base, and a short circuit or contact failure may occur. In such a case, the terminal base will be overheated to a high temperature. Particularly, if the terminal base is made of synthetic resin or the like, it may be melted or catch fire and the fire may spread to the apparatus main body.

### BRIEF SUMMARY OF THE INVENTION

The present invention has been made in consideration of the above drawbacks of the conventional art, and an object of the present invention is to provide a safe recessed luminaire, in which a terminal base is mounted on a lower surface of a fire-resistant terminal base attachment member projecting from a side of the main body of the luminaire.

To achieve the above object, a recessed luminaire according to an embodiment of the present invention comprises a main body including a light source; a terminal base attachment member, which is fire-resistant; and a terminal base connected to power wires, which are attached in parallel to a lower surface of the terminal base attachment member and extending in a direction of projection of the terminal base attachment member.

According to the present invention as will be described below, terms have the following definitions and technical meanings, unless otherwise defined specifically. A recessed luminaire means an illumination apparatus, for example, a downlight or an emergency light, which is recessed in a ceiling or wall. A light source may be an LED, an incandescent lamp, a fluorescent lamp, a high intensity discharge lamp, etc., and is not limited to a specific type of light source.

The present invention prevents the spread of fire resulting from, for example, overheating of the terminal base, so that a safe recessed luminaire can be provided. Further, the present invention prevents dust or the like from intruding into the terminal base.

Further, the present invention prevents fire from spreading to the apparatus main body.

Furthermore, the present invention allows the operator to attach the luminaire while visually observing an extending part of the terminal base attachment member after operating engaging means. Accordingly, the attachment operation can be efficiently performed.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of a recessed luminaire according to an embodiment of the present invention;

FIG. 2 is an exploded perspective view of the recessed luminaire;

FIG. 3 is a partially sectioned side view of the recessed luminaire;

FIG. 4 is a top view of the recessed luminaire;

FIG. 5 is a sectional view of the terminal base as viewed from a shielding wall;

FIG. 6 is a bottom view of the recessed luminaire; and

FIG. 7 is an explanatory view explaining a method of attaching the recessed luminaire.

### DETAILED DESCRIPTION OF THE INVENTION

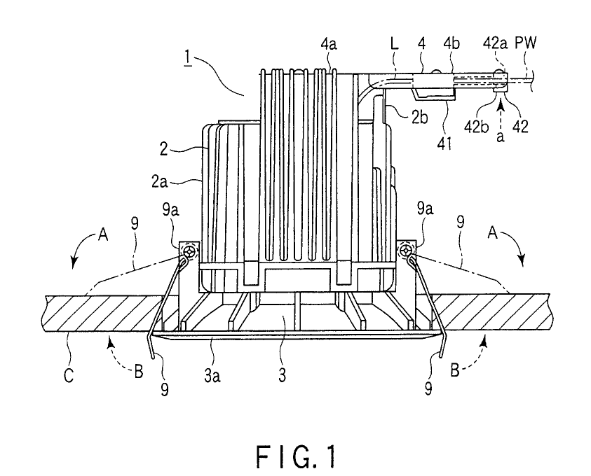

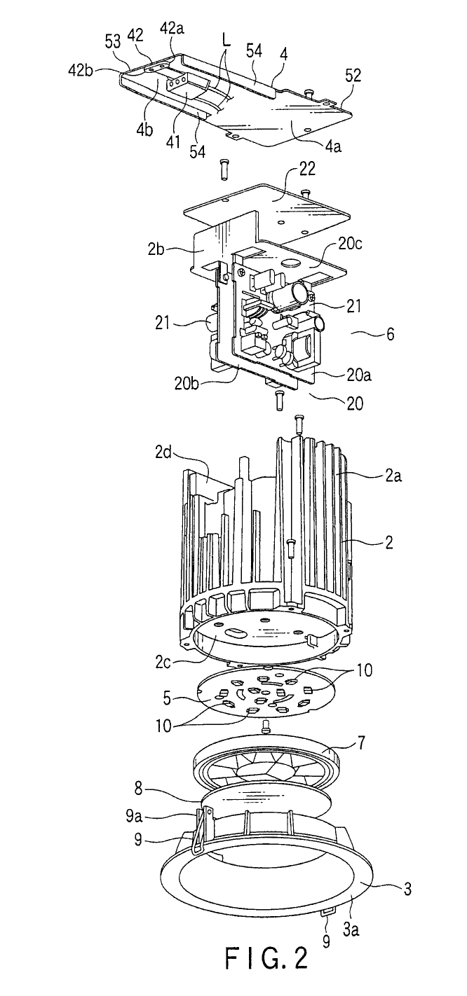

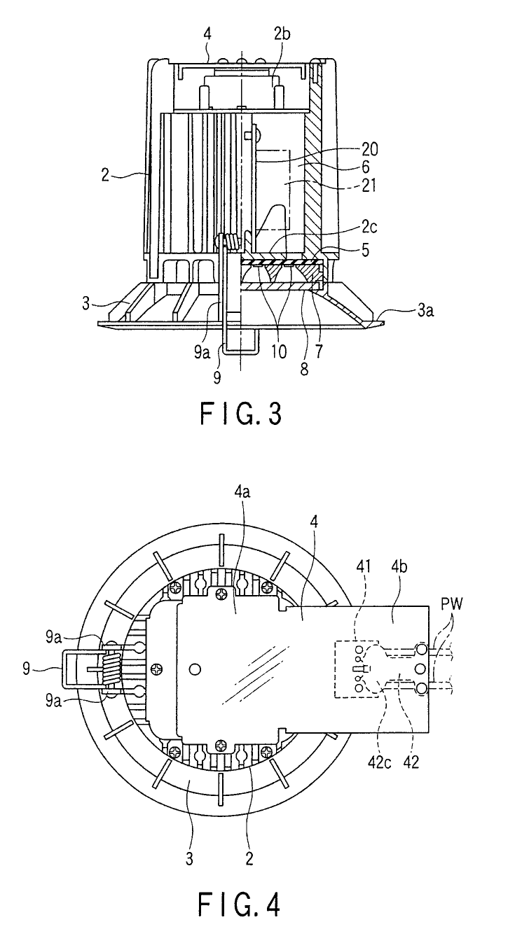

A recessed luminaire according to an embodiment of the present invention will be described below with reference to FIGS. 1 to 6. FIG. 1 is a side view showing a downlight as the recessed luminaire, FIG. 2 is an exploded perspective view of the downlight, FIG. 3 is a partially sectioned side view of the same, FIG. 4 is a top view of the same and FIG. 6 is a bottom view of the same.

The drawings show a recessed downlight as the recessed luminaire. A downlight main body 1 comprises a cylindrical body 2 which has a thermal conductivity, a decorative frame 3 and a terminal base attachment member 4 which are attached to the cylindrical body 2, a substrate 5 which is also attached to the cylindrical body 2 and on which LEDs (light-emitting devices) 10 as a light source are mounted, a power supply unit 6 including a power supply circuit board 20 contained in the cylindrical body 2, a reflector 7, and a translucent cover 8 attached in front of the reflector 7.

The cylindrical body 2 is an aluminum die-casting product, which is formed of a material having a high thermal conductivity. The outer surface of the cylindrical body 2 is coated by baked finish with white melamine-based resin paint. As long as the thermal conductivity is assured, the cylindrical body 2 may be formed of any other material. The cylindrical body 2 contains the power supply unit 6. The power supply unit 6 comprises two power supply circuit boards 20a and 20b, and a board attachment plate 20c to which the power supply circuit boards 20a and 20b are attached. One end of the board attachment plate 20c is bent upward and constitutes a shielding wall 2b. Electric components 21, such as a controlling IC, a transformer and a capacitor, are mounted on the power supply circuit boards 20a and 20b. The power supply circuit boards 20a and 20b are inserted into the cylindrical body 2 from above. Then, a lid 22 is put on and screwed to the cylindrical body from above, so that the power supply circuit boards 20a and 20b are contained inside, the cylindrical body 2 in a hermetically sealed state. In this state, the shielding wall 2b closes a cut portion 2d formed in a side wall of the cylindrical body 2. The power supply circuit board 20 is electrically connected to the substrate 5 on which the LEDs 10 are mounted, and includes a power supply circuit which turns on and off the LEDs 10. The outer surface of the cylindrical body 2 is provided with a plurality of radiating fins 2a extending vertically.

The decorative frame 3 is made of ABS resin and substantially umbrella-shaped. It is broaden toward one end, which is open and provided with an annular flange 3a. The other end of the decorative frame 3 is attached to the cylindrical body 2. A pair of attaching torsion springs 9, facing each other, are attached to the outer surface of the decorative frame 3 as engaging means. In other words, the pair of attaching torsion springs 9 are spaced apart at 180 degrees in the circumferential direction on the outer surface of the decorative frame 3. Each of the attaching torsion springs 9 has an attachment portion at its distal end. The attachment portion has a bent shape, which is rectangular in the front view and substantially V-shaped in the side view. A pair of support walls 9a are projected from the outer surface of the decorative frame 3 and a shaft is inserted between the support walls 9a. A coil portion of the attaching torsion spring 9 is supported by the shaft. Normally, inward elastic force as shown in FIG. 1 with an arrow A is exerted on the attaching torsion springs 9. The attaching torsion springs 9 can be rotated about the coil portions by operating the attachment portions.

The terminal base attachment member 4 is made of steel metal and has a substantially rectangular shape. It comprises an attachment portion 4a attached to the cylindrical body 2 and an extending portion 4b extending laterally from the cylindrical body 2. The terminal base attachment member 4 comprises a first end 52 fixed to the downlight main body 1 and a second end 53 located opposite to the first end 52. A substantially box-shaped terminal base 41 and a holder 42, both made of synthetic resin, are disposed on the lower surface of the extending portion 4b. The holder 42 is located in the second end 53. The terminal base attachment member 4 has bent portions 54 in peripheral portions thereof. The bent portions 54 project downward from the peripheral portions of the terminal base attachment member 4.

As regards the location of the terminal base 41 and the holder 42, the holder 42 is located in an edge portion of the extending portion 4b, and the terminal base 41 and the holder 42 are arranged in a line along the direction of extension of the extending portion 4b and fixed to the terminal base attachment member 4 by fixing means, such as screws. In other words, the terminal base 41 and the holder 42 are attached to the terminal base attachment member 4 so as to be arranged in a line along the direction in which the extending portion 4b is extending. Further, the attachment portion 4a lies over the lid 22 and screwed thereto on top of the cylindrical body 2 (see FIG. 2).

In the state where the terminal base attachment member 4 is attached to the cylindrical body 2, the shielding wall 2b faces the terminal base 41. This structure prevents the air around the terminal base 41 from flowing in the direction of extension of the terminal base attachment portion 4.

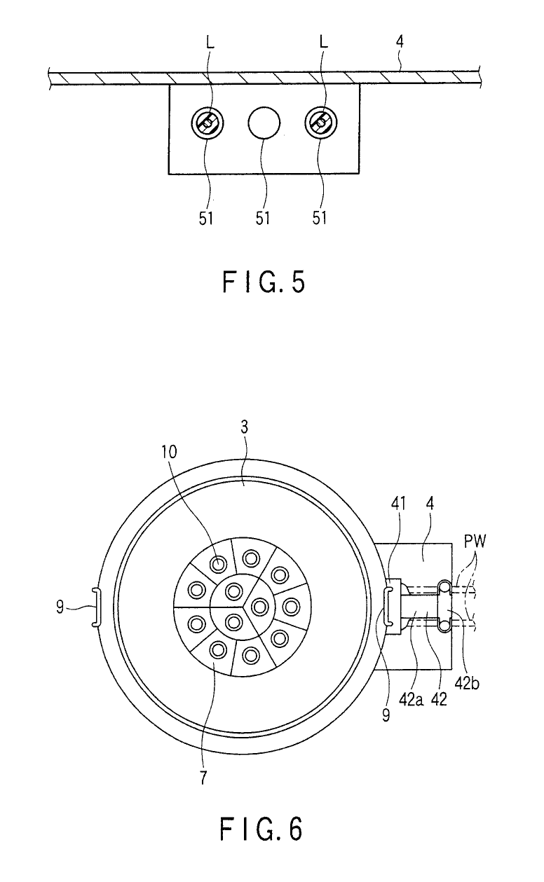

The power supply unit 6 is connected to the terminal base 41 by lead wires L or the like. Further, power wires PW from a commercial power source are connected to the terminal base 41. Thus, power is supplied to the power supply unit 6 via the terminal base 41. As shown in FIG. 5, the terminal base 41 has holes 51 through which the lead wires L are inserted. The holes 51 and the terminal base 41 faces the shielding wall 2b (see FIG. 1). When tensile force is applied to the power wires PW, the holder 42 holds the power wires PW so that the tensile force may not be exerted on the connecting portion between the terminal base 41 and the power wires PW. Thus, the holder 42 functions as a stopper against the tensile force of the power wires PW. More specifically, though not shown in the drawings in detail, the holder 42 comprises a main body piece 42a and a press piece 42b. The power wires PW arranged on the side of the main body piece 42a are held between the press piece 42b and the main body piece 42a by setting the press piece 42b to the main body piece 42a, as indicated by an arrow a in FIG. 1. Further, an expanding portion 42c is formed in one end portion of the main body piece 42a (see FIG. 4). The expanding portion 42c is sandwiched between the terminal base 41 and the lower surface of the extending portion 4b, when the terminal base 41 is attached to the lower surface of the extending portion 4b. One of the attaching torsion springs 9 is located in a position facing the lower surface of the terminal base attachment portion 4.

The LEDs 10, as a light source, are mounted on the main surface of the substrate 5 by surface mount technology. The substrate 5 is formed of a substantially circular flat plate made of glass epoxy resin, and attached to the bottom wall 2c of the cylindrical body 2 in close contact with each other. Thus, the substrate 5 is thermally connected to the cylindrical body 2. In the case of using an insulating material as the material of the substrate 5, ceramic or synthetic resin, which has an excellent heat radiating property and high tolerance, is applicable. In the case of using metal as the material of the substrate 5, it is preferable to apply aluminum or the like, which has high thermal conductivity and an excellent heat radiating property.

The reflector 7 made of white polycarbonate, ASA resin or the like is disposed on the main surface of the substrate 5. The reflector 7 performs a function of individually distribution-controlling lights emitted from the LEDs 10 and efficiently radiating the lights.

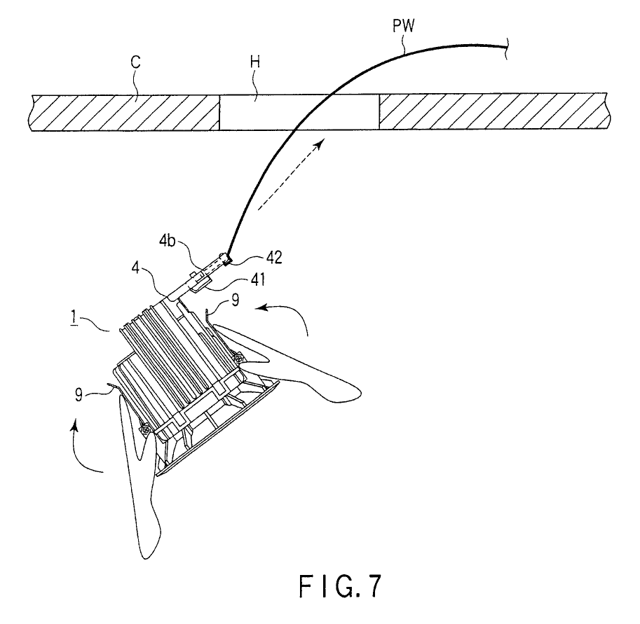

A method of attaching the downlight having the aforementioned configurations to the ceiling will be described with reference to FIG. 7. FIG. 7 is an explanatory view explaining the method of attachment. First the power wires PW wired in a space above the ceiling are connected to the terminal base 41, and held by the holder 42. In this state, the power wires PW are wired on the lower surface of the extending portion 4b of the terminal base attachment member 4 along the direction of extension. Then, the operator operates the attachment portions of the attaching torsion springs 9 as the engaging means with the hands to rotate and hold them against the elastic force thereof in the directions of arrows in the drawing (the directions of the arrows B in FIG. 1). The operator inclines the downlight main body 1 while supporting it, and inserts a distal end side of the extending portion 4b of the terminal base attachment member 4 into a hold H formed in the ceiling. As the downlight main body 1 is being inserted in the hole H, the operator releases the hands from the attaching torsion springs 9 and pushes up the downlight main body 1. As a result, as indicated by broken lines in FIG. 1, the attaching torsion springs 9 are recovered in the inward direction and brought into contact with the rear surface of the ceiling C. The elastic force causes the downlight main body 1 to rise and the flange 3a of the decorative frame 3 to be pressed against the circumferential edge of the hole H, thus attaching the downlight main body 1 to the surface of the ceiling C.

According to the attachment method described above, the power wires PW are wired along the direction of extension of the extending portion 4b of the terminal base attachment member 4; that is, the power wires PW extend in the direction of insertion into the hole H. Therefore, the main body 1 can easily be inserted through the hole H. Further, since one of the attaching torsion springs 9 is located in the position facing the lower surface of the terminal base attachment member 4, the operator can insert the extending portion 4b of the terminal base attachment portion 4 into the hole H, while supporting the main body 1 and visually observing the extending portion 4b after rotating the attachment portion of this attaching torsion spring 9. Thus, the working efficiency can be increased. Furthermore, in the state where the downlight main body 1 is attached to the ceiling, since the terminal base attachment member 4 extends laterally from the cylindrical body 2, the downlight is out of balance. However, since the downlight is supported by the attaching torsion spring 9 provided below the lower surface of the terminal base attachment member 4, the downlight can be kept in a stably attached state.

In the configuration described above, when the power supply unit 6 is turned on, a lighting circuit operates to supply the power to the substrate 5 and the LEDs 10 emit light. Most of the lights emitted from of the LEDs 10 directly pass through the translucent cover 8 and radiate forward, while some of the lights are reflected and distribution-controlled by reflecting surfaces of the reflector 7, then pass through the translucent cover 8 and radiate forward. On the other hand, heat generated from the LEDs 1 during this process is mostly transmitted from the rear surface of the substrate 5 to the bottom wall 2c of the cylindrical body 2, and then to the entire circumferential portion of the cylindrical body 2. The heat is dissipated during this transmission process.

While the downlight is being used, even if the terminal base 41 is overheated to a high temperature for some reason and melts or catches fire, fire spread can be avoided, since the terminal base attachment member 4 is made of steel metal and fire-resistant. Further, since the shielding wall 2b is provided on the circumferential wall of the cylindrical body 2, even if the terminal base 41 catches fire due to contact failure or the like, fire spread can be avoided. In addition, the shielding wall 2b blocks the air flow in the direction of extension of the terminal base attachment member 4 and can prevent fire from spreading. Thus, the shielding wall 2b can prevent fire from spreading to the power supply unit 6 or the like. Furthermore, since the terminal base 41 is attached to the lower surface of the terminal base attachment member 4, it is covered with the terminal base attachment member 4 and protected from intrusion of dust or the like.

According to the embodiment described above, fire spread due to overheating of the terminal base 41 or the like can be prevented, thereby increasing the degree of safety. Further, the downlight main body 1 can easily be attached, so that the efficiency in work can be increased. In addition, the terminal base 41 is protected from intrusion of dust or the like.

The present invention is not limited to the above embodiment, but may be modified variously without departing from the scope of the invention. For example, three attaching torsion springs as the engaging means may be arranged apart from one another at 120 degrees in the circumferential direction on the outer “surface of the decorative frame. Thus, the number of engaging means is not particularly limited. The engaging means is not limited to a spring, but any engaging means is applicable as long as it has a configuration that can support the luminaire to the attaching surface. As the light source, a LED, an incandescent lamp, a fluorescent lamp, a high intensity discharge lamp, etc. are applicable. Further, the recessed luminaire is not limited to a downlight but may be an emergency light etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recessed luminaire comprising:
a main body comprising a light source;
a terminal base attachment member, which is fire-resistant and which is fixed to the main body at a first end and extending laterally from the main body; and
a terminal base, which is disposed on a lower surface of the terminal base attachment member and to which power wires extending in parallel in a direction of extension of the terminal base attachment member are connected.

2. The recessed luminaire according to claim 1, further comprising a shielding wall which faces the terminal base under the lower surface of the terminal base attachment member and which is located between the terminal base and the main body.

3. The recessed luminaire according to claim 1, further comprising engaging means respectively having attachment portions, the attachment portion of one of the engaging means is located at a position facing the lower surface of the terminal base attachment member.

4. The recessed luminaire according to claim 1, further comprising a holder which is provided at a second end opposite to the first end of the terminal base attachment member and which holds the power wires connected to the terminal base.

5. The recessed luminaire according to claim 1, wherein the terminal base attachment member comprises a bent portion, which is provided on a peripheral portion of the terminal base attachment member and projects downward from the peripheral portion.
